(19) United States
(12) Patent Application Publication
(10) Pub. No.: US 2026/0098993 A1
(43) Pub. Date: Apr. 9, 2026

(54) BIREFRINGENCE COMPENSATION FOR OPTICAL METASURFACES

(71) Applicant: STMicroelectronics International N.V., Geneva (CH)

(72) Inventors: James DOWNING, Doune (GB); Enrico Giuseppe CARNEMOLLA, Edinburgh (GB); Lucie DILHAN, Saint Martin Dheres (FR)

(21) Appl. No.: 18/910,272

(22) Filed: Oct. 9, 2024

(51) Int. Cl. G02B 5/30; G02B 5/18

(52) U.S. Cl. CPC G02B 5/3083; G02B 5/1833

(57) ABSTRACT

An example optical metasurface, an example illumination system, an example optical imaging sensor, and an example method of manufacturing an optical metasurface configured to compensate for birefringent effects, are provided. The example optical metasurface includes a plurality of asymmetric nanostructures having a cross-section defined at least by a first dimension and a second dimension. Each asymmetric nanostructure is positioned to receive incident light at a nanostructure location. The first dimension and the second dimension are defined based on an angle of incidence of the incident light at the nanostructure location, and a phase retardation value associated with the nanostructure location. The first dimension and the second dimension of the asymmetric nanostructure are further defined to counteract a birefringent property at the angle of incidence.

### TECHNOLOGICAL FIELD

Embodiments of the present disclosure relate generally to optical metasurfaces, and more particularly, to techniques for birefringence compensation on optical metasurfaces.

### BACKGROUND

Optical technology may utilize various mechanisms to control, direct, and or pattern the transmission of light. For example, optical structures may leverage the properties of diffraction, reflection, refraction, and other variations of light to control the speed, phase, direction, and other properties of the light. Optical structures may be utilized in both focusing received light at a receiving element, such as a light-sensitive sensor, and/or directing transmitted light from a light source into an environment. Such optical structures may be utilized for various applications, including image capture, ranging and proximity sensors, depth map generation, LiDAR, beam steering applications, machine vision, and so on. One optical technology leveraging optical properties to direct light for various optical applications is an optical metasurface.

Applicant has identified many technical challenges and difficulties associated with undesired birefringent effects on optical metasurfaces. Through applied effort, ingenuity, and innovation, Applicant has mitigated problems related to birefringent effects on an optical metasurface by developing solutions embodied in the present disclosure, which are described in detail below.

### BRIEF SUMMARY

Various embodiments are directed to an example optical metasurface, an example illumination system, an example optical imaging sensor, and an example method of manufacturing an optical metasurface configured to compensate for birefringent effects. An example optical metasurface is provided. The example optical metasurface comprises a plurality of asymmetric nanostructures comprising a cross-section defined at least by a first dimension and a second dimension, each asymmetric nanostructure positioned at a nanostructure location and configured to receive incident light. The first dimension is defined based on an angle of incidence of the incident light at the nanostructure location, and a phase retardation value associated with the nanostructure location. The second dimension is defined based on the angle of incidence of the incident light at the nanostructure location, and the phase retardation value associated with the nanostructure location. The first dimension and the second dimension of the asymmetric nanostructure are defined to counteract a birefringent property at the angle of incidence.

In some embodiments, the plurality of asymmetric nanostructures are defined to generate a diffractive transmitted light pattern based on the phase retardation values at each of the nanostructure locations.

In some embodiments, the cross-section of each asymmetric nanostructure of the plurality of asymmetric nanostructures comprises a first axis and a second axis.

In some embodiments, the first axis is defined based on a first polarization state of the incident light, the angle of incidence of the incident light at the nanostructure location of the asymmetric nanostructure, and the phase retardation value associated with the nanostructure location, wherein the first polarization state of the incident light is aligned with the first axis of the asymmetric nanostructure.

In some embodiments, the second axis is defined based on a second polarization state of the incident light, the angle of incidence of the incident light at the nanostructure location of the asymmetric nanostructure, and the phase retardation value associated with the nanostructure location, wherein the second polarization state of the incident light is aligned with the second axis of the asymmetric nanostructure.

In some embodiments, the angle of incidence of the incident light is based on a distance between a center of the optical metasurface and the nanostructure location.

In some embodiments, a difference between the first dimension and the second dimension increases as the distance from the center of the optical metasurface of the nanostructure location increases.

In some embodiments, the first polarization state of incident light and the second polarization state of incident light are orthogonal.

In some embodiments, the asymmetric nanostructure is further defined by an orientation.

In some embodiments, the orientation is determined based on an azimuth angle from a base axis.

In some embodiments, an orientation angle of the asymmetric nanostructure is equal to the azimuth angle.

In some embodiments, a plurality of quantized azimuth angle groups are defined, wherein each quantized azimuth angle group is associated with a range of azimuth angles.

In some embodiments, the optical metasurface comprises sixteen quantized azimuth angle groups each quantized azimuth angle groups associated with a range of azimuth angles of 22.5 degrees.

An illumination system is further provided. In some embodiments, the illumination system comprises an optical illumination source, and an optical metasurface. The optical illumination source configured to transmit incident light through an optical illumination source. The optical metasurface comprising a plurality of asymmetric nanostructures comprising a cross-section defined at least by a first dimension and a second dimension, each asymmetric nanostructure positioned at a nanostructure location and configured to receive the incident light. The first dimension is defined based on an angle of incidence of the incident light at the nanostructure location, and a phase retardation value associated with the nanostructure location. The second dimension is defined based on the angle of incidence of the incident light at the nanostructure location, and the phase retardation value associated with the nanostructure location. The first dimension and the second dimension of the asymmetric nanostructure are defined to counteract a birefringent property at the angle of incidence.

In some embodiments, the angle of incidence is determined based on a position of the optical illumination source relative to the optical metasurface.

An optical imaging sensor is further provided. In some embodiments, the optical imaging sensor comprises an optical metasurface configured to transmit incident light toward an image sensor opposite the optical metasurface from the incident light. In some embodiments, the optical metasurface comprises a plurality of asymmetric nanostructures comprising a cross-section defined at least by a first dimension and a second dimension, each asymmetric nanostructure positioned at a nanostructure location and configured to receive the incident light. The first dimension is defined based on an angle of incidence of the incident light at the nanostructure location, and a phase retardation value associated with the nanostructure location. The second dimension is defined based on the angle of incidence of the incident light at the nanostructure location, and the phase retardation value associated with the nanostructure location. The first dimension and the second dimension of the asymmetric nanostructure are defined to counteract a birefringent property at the angle of incidence.

In some embodiments, the optical imaging sensor further comprises a sensor housing and an optical lens. The sensor housing comprising an aperture configured to receive the incident light. The optical lens positioned between the aperture and the optical metasurface, the optical lens configured to receive the incident light passing through the aperture.

A method of manufacturing an optical metasurface is further provided. In some embodiments, the method of manufacturing an optical metasurface comprises determining a phase map for the optical metasurface, wherein the phase map defines a diffractive transmitted light pattern. The method of manufacturing further comprises, for each nanostructure location on the optical metasurface: determining an angle of incidence of incident light at the nanostructure location; determining a phase retardation value at the nanostructure location based on the phase map; defining an asymmetric nanostructure based on the phase retardation value, comprising a cross-section defined at least by a first dimension and a second dimension. The first dimension defined based on an angle of incidence of the incident light at the nanostructure location, and a phase retardation value associated with the nanostructure location. The second dimension defined based on the angle of incidence of the incident light at the nanostructure location, and the phase retardation value associated with the nanostructure location. The first dimension and the second dimension of the asymmetric nanostructure are defined to counteract a birefringent property at the angle of incidence.

In some embodiments, the method of manufacturing further comprises: determining an azimuth angle of the nanostructure location from a base axis; and determining an orientation of the asymmetric nanostructure based on the azimuth angle.

In some embodiments, the method of manufacturing further comprises adding the asymmetric nanostructure and associated nanostructure location to an optical metasurface map.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example illumination system in accordance with an example embodiment of the present disclosure.

FIG. 2A illustrates an example optical imaging sensor in accordance with an example embodiment of the present disclosure.

FIG. 2B illustrates an example optical imaging sensor in a sensor housing in accordance with an example embodiment of the present disclosure.

FIG. 3 depicts a series of graphs illustrating an example phase error based on an angle of incidence of two distinct polarization states of light.

FIG. 4 illustrates cross-sections of example asymmetric nanostructures in accordance with an example embodiment of the present disclosure.

FIG. 5 illustrates an example phase map for a metasurface in accordance with an example embodiment of the present disclosure.

FIG. 6 illustrates an example angle of incidence map in accordance with an example embodiment of the present disclosure.

FIG. 7 illustrates an example azimuth angle based on a base axis and quantized azimuth angle groups in accordance with an example embodiment of the present disclosure.

FIG. 8 illustrates an example optical metasurface comprising a plurality of asymmetric nanostructures in accordance with an example embodiment of the present disclosure.

FIG. 9 illustrates an up-close view of a portion of an optical metasurface in accordance with an example embodiment of the present disclosure.

FIG. 10 illustrates an example phase error based on an angle of incidence for an optical metasurface utilizing asymmetric nanostructures in accordance with an example embodiment of the present disclosure.

FIG. 11 depicts an example method of manufacturing an optical metasurface in accordance with an example embodiment of the present disclosure.

FIG. 12 depicts a flow chart of an example method of manufacturing an optical metasurface in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with compensating for the effects of birefringence when transmitting light via an optical metasurface. As understood by those of skill in the field to which the present disclosure pertains, there are numerous example scenarios in which a system may benefit from compensating for the effects of birefringence at an optical metasurface.

In general, optical technology may utilize various mechanisms to control, direct, and or pattern the transmission of light. For example, optical structures may leverage the properties of diffraction, reflection, refraction, and other variations of light to control the speed, phase, direction, and other properties of the light. Optical structures may be utilized in both focusing received light at a receiving element, such as a light-sensitive sensor, and/or directing transmitted light from a light source into an environment. Such optical structures may be utilized for various applications, including image capture, ranging and proximity sensors, depth map generation, LiDAR, beam steering applications, machine vision, and so on.

One optical technology leveraging optical properties to direct light for various optical applications is an optical metasurface. Optical metasurfaces typically comprise a regular array of miniature nanostructures that act as local phase retarders on the surface of the optical component. A range of phase retardation may be achieved based on the geometric structure of the nanostructures. For example, changing the diameter of cylindrical nanostructures may alter the phase shift experienced by transmitted light. By selectively altering the phase of incident light using the nanostructures across the optical metasurface, transmitted light may utilize diffractive properties to generate a diffractive transmitted light pattern. A meta optical element comprises an optical element with at least one optical metasurface.

Birefringence may have an affect on the transmitted light passing through an optical metasurface. Birefringence is a phenomenon in which incident light having different polarizations experiences different refractive indices during propagation. Birefringence thus alters the transmission properties of transmitted light based on the polarization of the light. In addition, birefringent behavior may increase as the angle of incidence of incident light increases. The effects of birefringence at an optical metasurface may adversely affect the performance of the optical structure. For example, the desired diffractive transmitted light pattern may be degraded.

The various example embodiments described herein utilize various techniques to counter the effects of birefringence at an optical metasurface. For example, in some embodiments, asymmetric nanostructures are utilized on the surface of the optical metasurface to provide different phase retardation values based on the polarization of light entering the asymmetric nanostructures. The phase retardation value of a first polarization of light may be determined by a first dimension of the asymmetric nanostructure, while the phase retardation value of a second polarization of light may be determined based on a second dimension of the asymmetric nanostructure. By determining the birefringent effect at a particular location on the optical metasurface and selecting the dimensions of the asymmetric nanostructures based on the birefringent effect and the desired diffractive transmitted light pattern, the birefringent effect of an optical metasurface may be counteracted.

One factor in determining the birefringent effect at an optical metasurface is the angle of incidence of incident light to the optical metasurface. In general, the greater the angle of incidence, the greater the birefringent effect on transmitted light. Thus, determining the angle of incidence based on the location of an asymmetric nanostructure on the surface of an optical metasurface may be used to further define the dimensions of the asymmetric nanostructure.

In addition, the orientation of the asymmetric nanostructure may change the effect of an asymmetric nanostructure on the various polarization states of incident light. Utilizing an azimuth angle relative to a base axis at each nanostructure location, an orientation of the asymmetric nanostructure may be determined. Positioning the asymmetric nanostructure such that the first dimension is associated with the first polarization state of light and the second dimension is associated with the second polarization state of light may further compensate for the birefringent effects.

As a result of the herein described example embodiments, the precision and accuracy of optical metasurfaces may be greatly improved. In addition, the efficiency with which transmitted light through the optical metasurface is transmitted in a diffractive pattern may be increased.

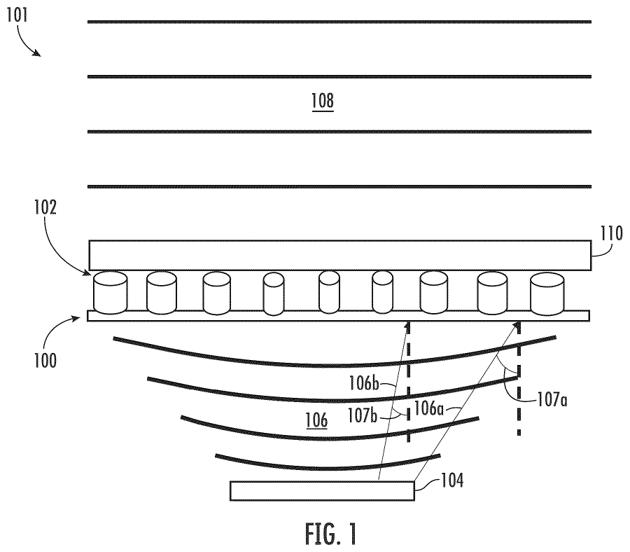

Referring now to FIG. 1, an example illumination system 101 (e.g., optical transmission source, optical diffuser) comprising an optical metasurface 100 is provided. As depicted in FIG. 1, the optical metasurface 100 of the illumination system 101 comprises a plurality of nanostructures 102 positioned to receive incident light 106 generated by an illumination source 104 at the optical metasurface 100 and generate a diffractive transmitted light pattern 108 through an optical lens 110. As further depicted in FIG. 1, the incident light 106 encounters the optical metasurface 100 at an angle of incidence 107a, 107b based on a location at the optical metasurface 100.

As depicted in FIG. 1, the example optical metasurface 100 includes a plurality of nanostructures 102. A nanostructure 102 is any pillar, column, cylinder, or other structure on the surface of an optical metasurface 100 comprising a high refractive index material compared to a surrounding low refractive index material, such that incident light 106 encountering a first end of the nanostructure 102 is transmitted through the nanostructure. In some embodiments, the nanostructure 102 may comprise silicon, while the surrounding material comprises silicon dioxide. The dimensions of the nanostructure 102 defines the phase retardation of the incident light 106 transmitted through the nanostructure 102. Phase retardation is the phase offset intruded by the nanostructurev102. For example, in some instances a nanostructure 102 may cause a phase offset between 0 and 2π.

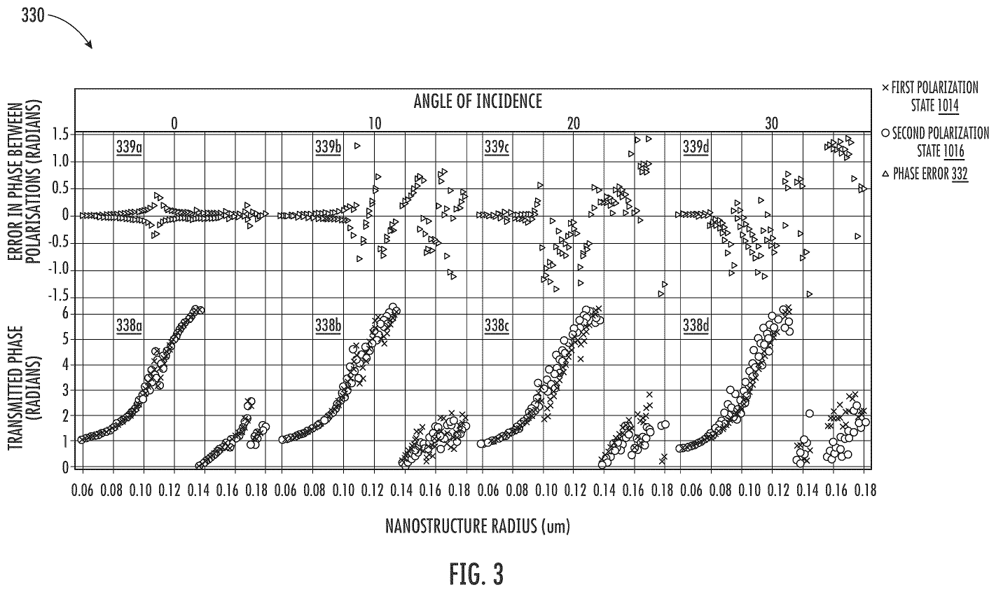

In an instance in which the wave guide structure 102 is cylindrical or near cylindrical, the phase retardation may be defined on the diameter of the nanostructure 102. Full phase freedom from 0 to 2π may be achieved by adjusting the diameter of the cylindrical nanostructure 102 without changing the height of the nanostructure 102. Achieving full phase freedom without changing the height of the nanostructure 102 is particularly useful in an creating a low profile optical device. As further discussed in relation to FIG. 3, an asymmetric nanostructure, such as an ellipse may exhibit different phase retardation depending on the polarization and angle of incidence of the incident light 106 transmitted through the asymmetric nanostructure.

In addition, nanostructures 102 may strongly confine energy locally when compared to other diffractive optic devices. Confined energy through the nanostructures 102 results in a more efficient optical device, as generated and/or received light is not scattered and/or reflected.

As further depicted in FIG. 1, the example illumination system 101 is configured to generate a diffractive transmitted light pattern 108 based on the nanostructures 102 of the optical metasurface 100. A diffractive transmitted light pattern 108 is any light output pattern resulting from the transmission of incident light 106 through the nanostructures 102 of the optical metasurface. Transmitted light through each of the nanostructures 102 may experience various shifts in phase. Phase shifts from different nanostructures 102 may result in constructive and destructive interference patterns. The constructive and destructive interference may result in various diffractive transmitted light patterns 108. For example, constructive interference at a specific point may result in a focused diffractive transmitted light pattern 108. Constructive interference at a plurality of points may result in a dot pattern diffractive transmitted light pattern 108. Due to the full phase freedom at each of the nanostructures 102, almost any diffractive transmitted light pattern 108 may be formed.

As further depicted in FIG. 1, the example illumination system 101 includes an illumination source 104. The incident light 106, 106a, 106b encountering the optical metasurface 102 is generated by an illumination source 104. An illumination source 104 comprises any light source or array of light sources comprising a semiconductor, diode, or other photon emitting structure configured to generate optical output, such as incident light 106. An illumination source 104 may be configured to generate light output at a specific wavelength or spectrum of wavelengths. In some embodiments, the illumination source 104 may comprise one or more vertical cavity surface emitting lasers (VCSELs). The light output of the illumination source 104 may comprise unpolarized light. Unpolarized light may include light exhibiting random polarizations, includes time varying polarization.

The angle at which rays of incident light 106a, 106b encounter an optical metasurface 100, relative to the normal of the optical metasurface 100 is referred to as an angle of incidence 107a, 107b as depicted in FIG. 1. The angle of incidence 107a, 107b may vary based on the location on the optical metasurface 100. For example, the angle of incidence 107b of a ray of incident light 106b encountering the optical metasurface 100 near the center may be less than an angle of incidence 107a of a ray of incident light 106a encountering the optical metasurface 100 near the periphery. In a transmitting application, as shown in FIG. 1, the angle of incidence 107a, 107b may also depend on the size of the optical metasurface 100, the size of the illumination source 104, the type of illumination source 104, the distance between the illumination source 104 and the optical metasurface 104, and other attributes of the optical metasurface 100 and illumination source 104.

As further depicted in FIG. 1, the illumination system 101 includes an optical lens 110. An optical lens 110 is any transparent and/or semi-transparent device configured to enable the passage and/or distortion of light. An optical lens 110 may point, focus, or direct the light passing through the optical metasurface 100 into the far field.

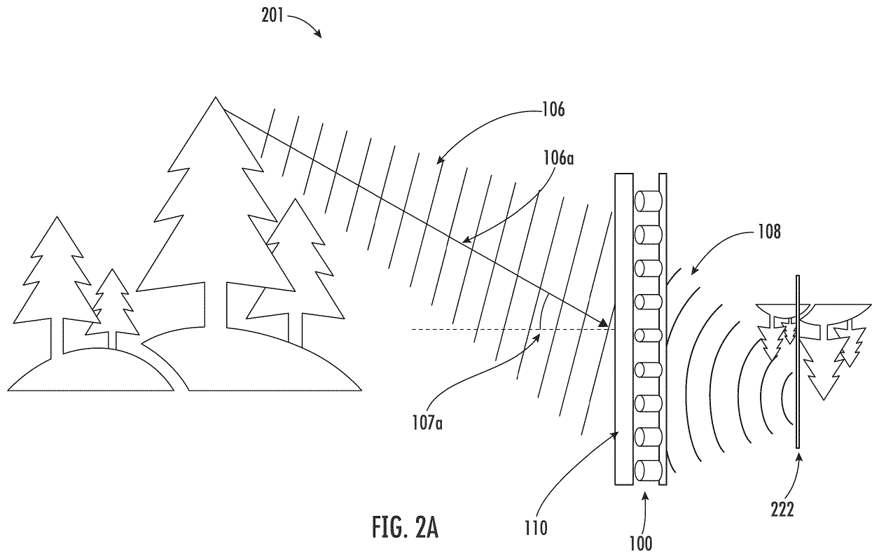

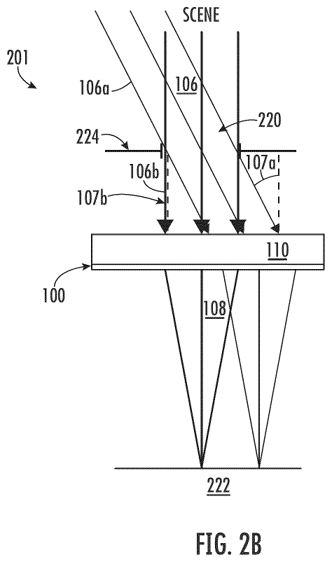

Referring now to FIG. 2A, an example optical imaging sensor 201 is provided. As depicted in FIG. 2A, the optical imaging sensor 201 is configured to receive incident light 106 at an angle of incidence 107a. The incident light 106 passes through an optical lens 110 and an optical metasurface 100 comprising a plurality of nanostructures (e.g., nanostructures 102 as depicted in FIG. 1). As further depicted in FIG. 2A, a diffractive transmitted light pattern 108 is transmitted toward an image sensor 222.

As depicted in FIG. 2A, the example optical imaging sensor 201 may include an image sensor 222. An image sensor 222 comprises one or more light sensitive devices configured to receive light transmitted from the optical metasurface 100 (e.g., diffractive transmitted light pattern 108) and generate an electrical output corresponding to the intensity of light received at the image sensor 222 during an integration period.

Referring now to FIG. 2B, in some embodiments, the optical imaging sensor 201 may be enclosed in a sensor housing 224 comprising an aperture 220. An aperture 220 comprises a hole or opening primarily configured to limit the amount of incident light 106 allowed to propagate into the sensor housing 224, through the optical lens 110, through the optical metasurface 100, and toward the image sensor 222.

As depicted in FIG. 2A, the example optical imaging sensor 201 includes an aperture 220 in a sensor housing 224. As depicted in FIG. 2A, the rays of incident light 106a, 106b pass through the aperture 220 and encounter the optical lens 110 and optical metasurface 100, at an angle of incidence 107a, 107b relative to the normal of the optical metasurface 100. The angle of incidence 107a, 107b may vary based on the location on the optical metasurface 100. For example, a ray of incident light 106a passing through the aperture 220 from directly in front of the optical imaging sensor 201 may have a smaller angle of incidence 107a than the angle of incidence 107a of a ray of incident light 106a passing through the aperture 220 from a wider field of view. In a receiving application, as shown in FIG. 2A, the angle of incidence 107a, 107b may also depend on the size of the optical metasurface 100, the size of the aperture 220, the distance between the aperture 220 and the optical metasurface 104, the position of the aperture 220 relative to the optical metasurface 100, and other attributes of the optical metasurface 100 and aperture 220.

Referring now to FIG. 3, an example graph 330 depicting birefringent effects of an optical metasurface (e.g., optical metasurface 100) is provided.

Birefringence is an optical property of a material (e.g., nanostructures 102) having a refractive index that depends on the polarization and/or propagation direction of incident light (e.g., incidence light 106). In other words, the speed and/or phase retardation of light passing through a nanostructure on an optical metasurface may be different based on the polarization state or, more specifically, the orientation of linear polarization of the incident light.

For example, in FIG. 3, the graphs 338a-338d depict the transmitted phase in radians of a first polarization state 334 (e.g., orthogonal linear polarization) of light and a second polarization state 336 (e.g., orthogonal linear polarization) of light over an increasing nanostructure radius. As depicted in graphs 338a-338d, the transmitted phase (e.g., phase retardation) of the nanostructure is different based on the polarization of the incident light. Graphs 339a-339d depict the phase error 332, or difference between the transmitted phase of the first polarization state 334 of light and the second polarization state 336 of light, further illustrating the birefringent properties of the nanostructures. The depicted graphs 338a-338d depict the response for nanostructures with a constant radius (e.g., circular cross-section when viewed from an end).

As further depicted in FIG. 3, the phase error 332 increases as the angle of incidence of the incident light increases. As depicted in FIG. 3, the first set of graphs 338a, 339a depict the transmitted phase and error at an angle of incidence of 0 degrees. The second set of graphs 338b, 339b depict the transmitted phase and error at an angle of incidence of 10 degrees. The third set of graphs 338c, 339c depict the transmitted phase and error at an angle of incidence of 20 degrees. And the fourth set of graphs 338d, 339d depict the transmitted phase and error at an angle of incidence of 30 degrees. As shown in FIG. 3, the phase error 332 depicted in graph 339a-339d increases as the angle of incidence of the incident light to the optical metasurface increases.

Birefringence of an optical metasurface may adversely affect the precision and performance of an optical system (e.g., optical imaging sensor, illumination system) utilizing an optical metasurface comprising nanostructures. Unpolarized light may propagate through the optical metasurface at different rates, adversely affecting the diffractive transmitted light pattern. Such adverse affects may be particularly problematic in an optical system comprising a wide field of view, as a wide field of view may increase the angle of incidence at portions of the optical metasurface.

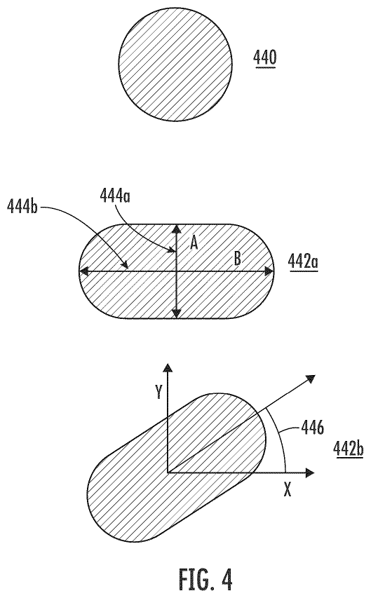

Referring now to FIG. 4, an example circular nanostructure 440 and example asymmetric nanostructures 442a, 442b are provided. As described in relation to FIG. 1, the phase retardation of a circular nanostructure (e.g., circular nanostructure 440) may be defined by the diameter of the nanostructure. For example, altering the diameter of the nanostructure may alter the phase offset experienced by incident light transmitted through the circular nanostructure 440. However, as shown in FIG. 3 the nanostructures may exhibit birefringent properties, meaning, the phase offset experienced by incident light transmitted through the circular nanostructure 440 may vary based on the polarization state of the incident light.

Asymmetric nanostructures 442a, 442b may be designed to counteract the birefringent properties of a circular nanostructure 440, particularly occurring when wavefront has an angle of incidence wider than zero degrees from the normal of the optical metasurface. As depicted in FIG. 4, an asymmetric nanostructure 442a may be defined by two radii (e.g., a first dimension 444a and a second dimension 444b). The asymmetric cross-section of the asymmetric nanostructures 442a may behave as nanostructures with different radii based on the polarization and/or direction of the incident light. The first dimension 444a and the second dimension 444b are adjusted separately to achieve the wanted phase retardations to be imparted to the components of the incident light in the two orthogonal polarizations. For example, the first dimension 444a may be significantly different from the second dimension 444b causing a first polarization state of incident light to experience a different phase retardation than a second polarization state of the incident light.

In some embodiments, an asymmetric nanostructure 442a may comprise an elliptical cross-section, wherein the first dimension 444a corresponds to a minor axis of the ellipse, and the second dimension 444b corresponds to a major axis of the ellipse. In some embodiments, the first dimension 444a and the second dimension 444b of the asymmetric nanostructure 442a may be the same, resulting in a circular nanostructure (e.g., circular nanostructure 440).

As further depicted in FIG. 4, an asymmetric nanostructure 442b may be defined by an orientation. In some embodiments, the orientation of an asymmetric nanostructure 442b may be defined by an offset angle 446 from a base axis (e.g., x or y axis) defining the position of the asymmetric nanostructure 442b. For example, an optical metasurface may define a first axis crossing through a center of the optical metasurface and a second axis perpendicular to the first axis and also crossing through the center of the optical metasurface. By adjusting the orientation of the asymmetric nanostructure 442b, the geometry of the asymmetric nanostructure 442b may affect different polarizations of incident light.

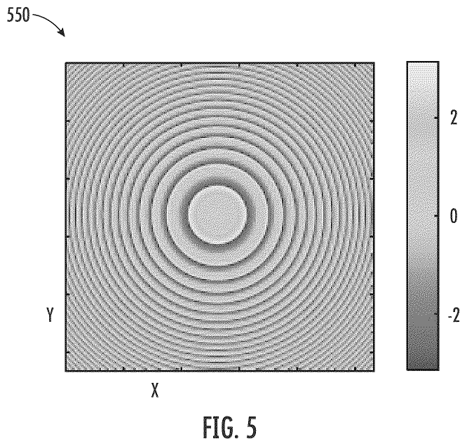

Referring now to FIG. 5, an example phase map 550 applied to a surface of an optical metasurface is provided. A phase map 550 may be defined across the surface of an optical metasurface to obtain a specific diffractive transmitted light pattern in the incident light transmitted through the optical metasurface. The phase map 550 defines the phase retardation, for example between −π and π, at each nanostructure location (e.g., x, y location) on the optical metasurface in order to obtain the desired specific diffractive transmitted light pattern. For example, in an instance in which a focused diffractive transmitted light pattern is desired, the phase map 550 defines the phase retardation at each nanostructure location on the optical metasurface to obtain a focused wavefront. The phase map 550 may dictate the structure of the nanostructure at each nanostructure location on the optical metasurface. For example, the radius of a circular optical nanostructure may be adjusted to change the phase of the transmitted incident light.

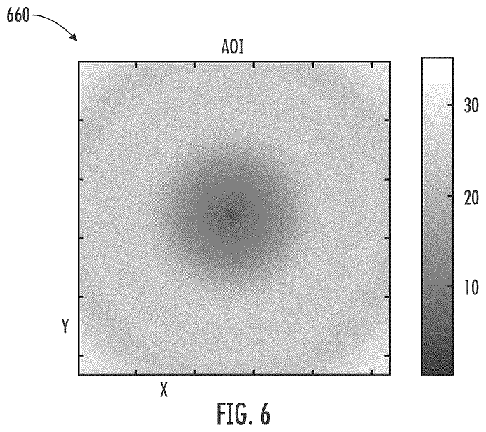

Referring now to FIG. 6, an angle of incidence (AOI) map 660 is provided. An angle of incidence map 660 may be defined across the surface of an optical metasurface based on the physical structure of an optical system, for example, the size of apertures, illumination sources, optical metasurfaces, and so on. The angle of incidence map 660 estimates the angle of incidence of incident light at each nanostructure location (e.g., x, y location) on the optical metasurface. For example, as shown in FIG. 6, the angle of incidence of incident light near the center of the optical metasurface is close to 0 degrees, however, the angle of incidence of incident light near the periphery of the optical metasurface is greater than 30 degrees. As described herein, the birefringent effects of the nanostructures on incident light may be affected by the angle of incidence of the incident light. Thus, the dimensions of the nanostructures may be defined based on the angle of incidence map 660 and the angle of incidence at each nanostructure location on the optical metasurface. For example, the difference between the first dimension and the second dimension may become greater as the angle of incidence increases.

In some embodiments, the angle of incidence map 660 may include quantized angle of incidence groups. For example, portions of the optical metasurface may be grouped in a representative angle of incidence. In such an example, all regions may be grouped into a closest matching representative angle of incidence. For example, a zero degree quantized angle of incidence group at or near the center of the optical metasurface; a 10 degree quantized angle of incidence group at a distance further from the center of the optical metasurface than the zero degree quantized angle of incidence group; a 20 degree quantized angle of incidence group at a distance further from center than the 10 degree quantized angle of incidence group; and so on.

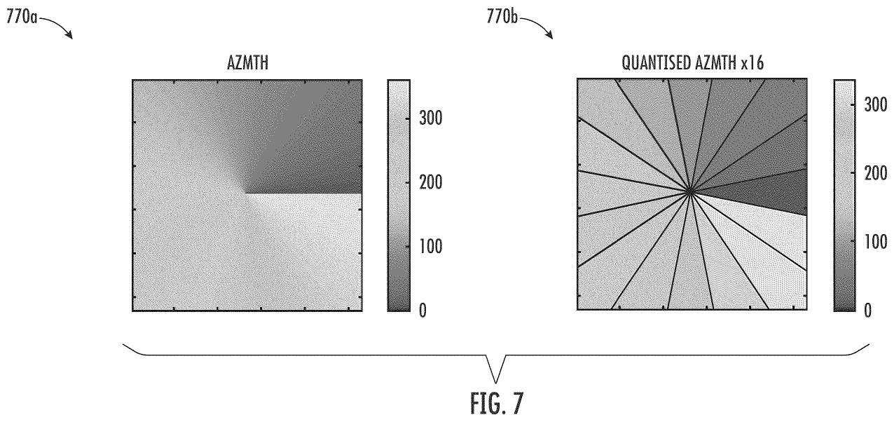

Referring now to FIG. 7, an azimuth angle map 770a is provided. An azimuth angle map 770a may be defined across the surface of an optical metasurface relative to a base axis passing through the center of the optical metasurface. The azimuth angle map 770a determines the azimuth at each nanostructure location (e.g., x, y location) on the optical metasurface based on the coordinate location. For example, utilizing an x, y location, the azimuth location at a particular nanostructure location having coordinates x and y may be determined by:

$$θ = atan 2 ( y , x )$$

where θ is the azimuth angle at the particular nanostructure location. As depicted in FIG. 7, the azimuth angle may range between 0 and 360 degrees.

The azimuth angle of a nanostructure at a nanostructure location may determine the orientation of the nanostructure. For example, the first dimension and second dimension of a nanostructure may be selected based on the angle of incidence and desired phase retardation of a nanostructure location on the optical metasurface. Selecting the orientation of the nanostructure ensures the nanostructure is configured to receive incident light and impose the determined phase retardation based on the polarization state of incident light at the nanostructure.

In some embodiments, the azimuth angle may be quantized into a quantized azimuth angle map 770b. The quantized azimuth angle map 770b may include quantized azimuth angle groups wherein each nanostructure location in the quantized azimuth angle group is assigned the same azimuth angle. In an example in which the optical metasurface is divided into 16 quantized azimuth angle groups, a first group comprising all nanostructure locations having an azimuth angle between −12.25 degrees and +12.25 degrees may be estimated by an azimuth angle of 0 degrees. Similarly, all nanostructure locations having an azimuth angle between 12.25 degrees and 34.75 degrees may be estimated by an azimuth angle of 22.5 degrees, and so on.

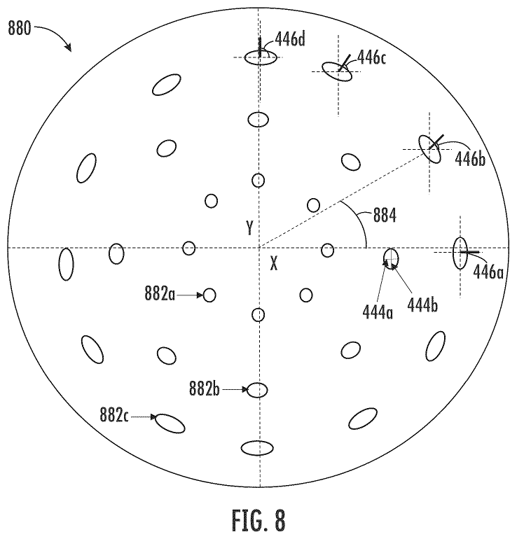

Referring now to FIG. 8, an example optical metasurface 880 is provided. As depicted in FIG. 8, the example optical metasurface 880 includes a plurality of nanostructures (e.g., nanostructure 882a-882c) at a nanostructure location. Each nanostructure comprises a first dimension (e.g., first dimension 444a) and a second dimension (e.g., second dimension 444b). In addition, each nanostructure comprises an orientation (e.g., orientation 446a-446d).

As depicted in FIG. 8, the dimensions (e.g., first dimension 444a, second dimension 444b) of each nanostructure may be defined based on the desired phase retardation at the particular nanostructure location. In addition, the dimensions may be defined to compensate for birefringent effects at the particular nanostructure location. For example, as depicted in FIG. 5, a phase map may be defined for each location on the surface of an optical metasurface 880 in order to generate a particular diffractive transmitted light pattern. The dimensions of each nanostructure are selected to generate the phase retardation indicated on the phase map at the particular nanostructure location. However, the birefringent properties of the nanostructures cause different phase retardation for different polarizations of incident light. Thus, the first dimension and second dimension are selected independently to achieve the desired phase retardation for at least a first polarization state and a second polarization state at the particular nanostructure location. As described in relation to FIG. 6, the angle of incidence of incident light effects the birefringent effect of the nanostructure. As such, an angle of incidence map (e.g., angle of incidence map 660) may be determined to indicate the angle of incidence of incident light at each nanostructure location. The first and second dimension are selected based on the angle of incidence at the particular nanostructure location.

As further depicted in FIG. 8, an x, y coordinate system may be defined on the surface of the optical metasurface based on a base axis (e.g., x axis) passing through the center of the optical metasurface 880 and a perpendicular axis (e.g., y axis) also passing through the center of the optical metasurface 880. The x, y coordinate system may be used to define nanostructure locations on the surface of the optical metasurface 880. For example, a two-dimensional array of nanostructure locations, each with an x and y coordinate may be defined.

In addition, an azimuth angle 884 for each nanostructure location may be determined relative to the base axis (e.g., x axis). For example, nanostructure locations at the positive base axis may have an azimuth angle of 0 degrees relative to the base axis and increase in a counterclockwise direction from the base axis. In such an example, nanostructure locations at the positive y axis are at 90 degrees; nanostructure locations at the negative x axis are at 180 degrees; nanostructure locations at the negative y axis are at 270 degrees; all the way to 360 degrees.

As depicted in FIG. 8, the orientation 446a-446d of each nanostructure is based at least in part on the azimuth angle (e.g., azimuth angle 884). Each nanostructure comprises an orientation based on the dimensions of the nanostructure. For example, a nanostructure comprising a major axis and a perpendicular minor axis may define a base axis that is co-linear with the minor axis, or vice versa. As depicted in FIG. 8, the example nanostructure 446a defines a base axis relative to the minor axis of the nanostructure 446a. Thus, the nanostructure 446a is at an orientation of 0 degrees relative to the base axis. Similar nanostructures 446b-446d are positioned at a different orientation relative to the base axis. For example, nanostructure 446b is positioned at an orientation at or near 30 degrees; nanostructure 446c is positioned at an orientation at or near 70 degrees; and nanostructure 446d is positioned at an orientation at or near 90 degrees. In some embodiments, the orientation of the nanostructure may be equivalent to the azimuth angle 884 of the nanostructure location of the nanostructure. In some embodiments, the azimuth angle may be quantized into quantized azimuth angle groups. In such an embodiment, each nanostructure location in a portion of the optical metasurface is assigned the same azimuth angle. Utilizing quantized azimuth angle groups may simplify the manufacturing process by limiting the number of orientations of nanostructures. The orientation of the nanostructure may dictate the phase retardation relative to different polarization states of incident light at the nanostructure location.

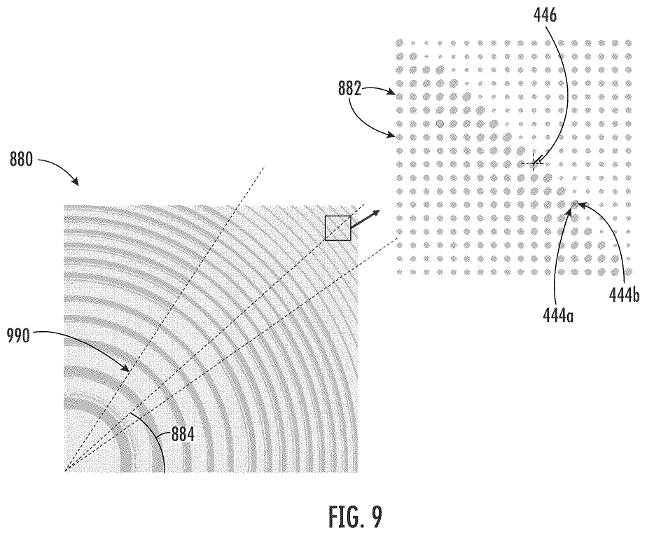

Referring now to FIG. 9, a close-up view of an example metasurface 880 comprising a plurality of nanostructures 882 is provided. As depicted in FIG. 9, each of the nanostructures includes a first dimension 444a and a second dimension 444b based on the desired phase retardation at the nanostructure location and the birefringent effects on different polarization states of light at the nanostructure location. The birefringent effects may be determined based at least on the angle of incidence of incident light at the particular nanostructure location.

As further depicted in FIG. 9, each nanostructure 882 is positioned at an orientation 446. The orientation 446 of a nanostructure 882 may be based at least in part on the azimuth angle 884 of the particular nanostructure location. As depicted in FIG. 9, the orientation 446 of the nanostructures 446 is based on a quantized azimuth angle group 990 associated with a range of azimuth angles. Thus, all nanostructures 882 in a particular quantized azimuth angle group 990 may be positioned in the same orientation based on the quantized azimuth angle group 990.

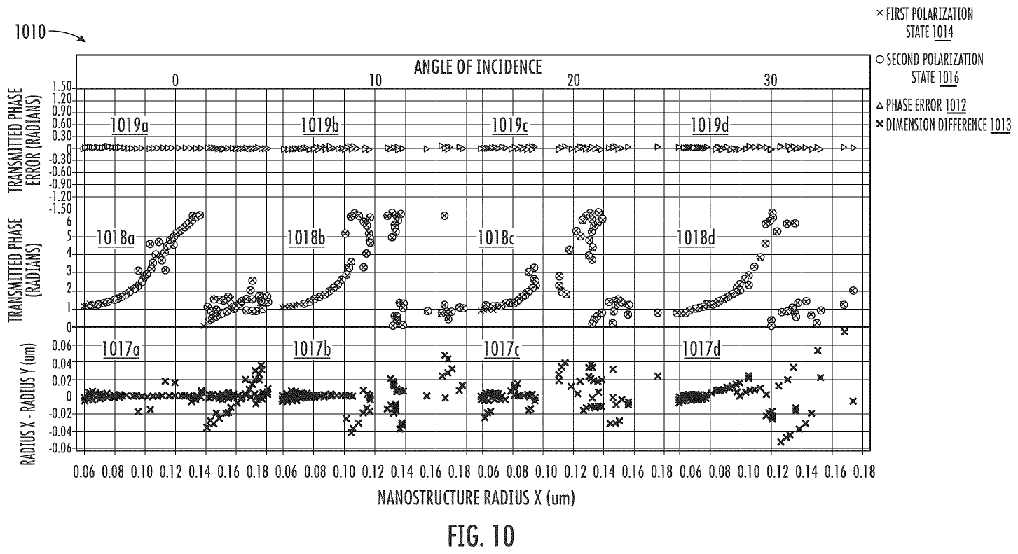

Referring now to FIG. 10, an example graph 1010 depicting the counteraction of birefringent effects of an optical metasurface comprising asymmetric nanostructures is depicted.

As depicted in FIG. 10, the graphs 1017a-1017d depict a dimension difference 1013 indicating a difference between a first dimension (radiusX) and a second dimension (radiusY) of an example nanostructure. Each graph 1017a-1017b depicts the dimension difference 1013 at a different angle of incidence of the incoming incident light. For example, graph 1017a shows the dimension difference 1013 at an angle of incidence of 0 degrees; graph 1017b shows the dimension difference 1013 at an angle of incidence of 10 degrees; graph 1017c shows the dimension difference 1013 at an angle of incidence of 20 degrees; and graph 1017d shows the dimension difference 1013 at an angle of incidence of 30 degrees. As shown in graphs 1017a-1017d, in some embodiments, the difference between the first dimension and the second dimension may increase as the angle of incidence increases to compensate for the increased effect of birefringence.

As further depicted in FIG. 10, the graphs 1018a-1018d depict the transmitted phase in radians of a first polarization state 1014 of light and a second polarization state 1016 of light over an increasing nanostructure radius. As depicted in graphs 1018a-1018d, the asymmetric dimensions of the nanostructure compensate for the difference in transmitted phase (e.g., phase retardation) such that the transmitted phase is nearly identical for the first polarization state 1014 and the second polarization state 1016 of light. Graphs 1019a-1019d depict the phase error 1012, or difference between the transmitted phase of the first polarization state 1014 of light and the second polarization state 1016 of light, further illustrating the birefringent properties of the nanostructures have been compensated for by the asymmetric nanostructure.

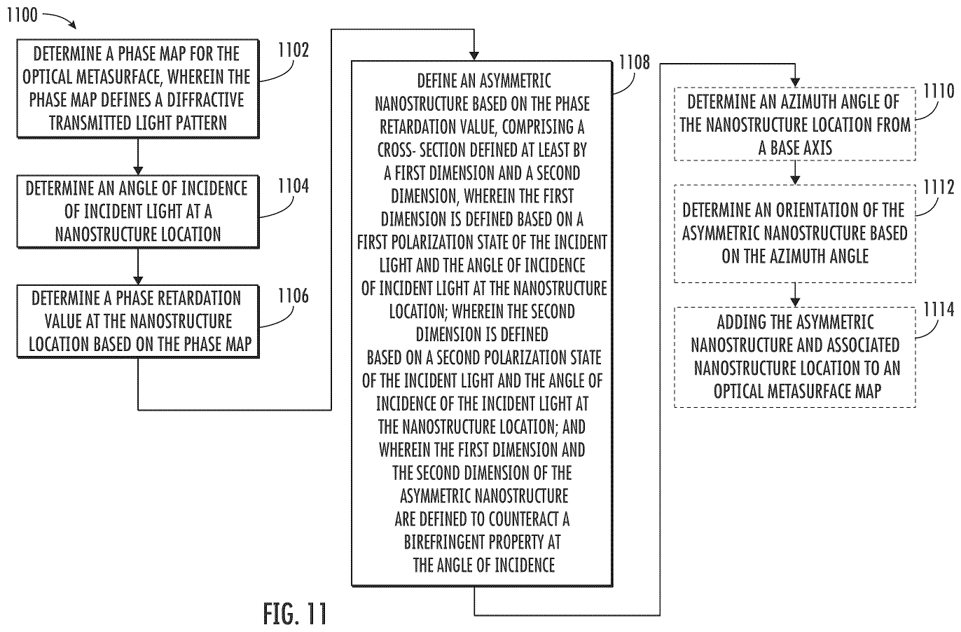

Referring now to FIG. 11, an example method of manufacturing 1100 (e.g., design) an optical metasurface (e.g., optical metasurface 880) is provided. As depicted in FIG. 11, at block 1102 the method of manufacturing 1100 includes determining a phase map (e.g., phase map 550) for the optical metasurface, wherein the phase map defines a diffractive transmitted light pattern (e.g., diffractive transmitted light pattern 108). The phase map may indicate the desired phase retardation at each nanostructure location on the optical metasurface to generate the desired diffractive transmitted light pattern transmitted by the optical metasurface.

At block 1104, the method of manufacturing 1100 includes at each nanostructure location on the optical metasurface, determining an angle of incidence (e.g., angle of incidence 107a, 107b) of incident light (e.g., incident light 106) at the nanostructure location. The angle of incidence at each nanostructure location may be dependent on the optical structures comprising the optical system. For example, physical properties of an aperture, an illumination source, a lens, the optical metasurface, and other similar optical structures. In some embodiments, an angle of incidence map (e.g., angle of incidence map 660) may be generated. The angle of incidence map may indicate the determined angle of incidence at each nanostructure location on the optical metasurface based on the optical system.

At block 1106, the method of manufacturing 1100 includes at each nanostructure location on the optical metasurface, determining a phase retardation value at the nanostructure location based on the phase map. The phase retardation value corresponds to the desired phase retardation to be generated at the particular nanostructure location of the optical metasurface.

At block 1108, the method of manufacturing 1100 includes at each nanostructure location on the optical metasurface, defining an asymmetric nanostructure (e.g., asymmetric waveguide 442a, 442b, 882) based on the phase retardation value, comprising a cross-section defined at least by a first dimension (e.g., first dimension 444a) and a second dimension (e.g., second dimension 444b), wherein the first dimension is defined based on a first polarization state of the incident light and the angle of incidence of incident light at the nanostructure location, wherein the second dimension is defined based on a second polarization state of the incident light and the angle of incidence of the incident light at the nanostructure location; and wherein the first dimension and the second dimension of the asymmetric nanostructure are defined to counteract a birefringent property at the angle of incidence. As described herein, the birefringent properties of an asymmetric waveguide may depend on the angle of incidence of incident light. Thus, the first dimension of the asymmetric waveguide may be selected to generate the desired phase retardation value based on the angle of incidence and the first polarization state of light. The second dimension of the asymmetric waveguide may be selected to generate the same desired phase retardation value based on the angle of incidence and the second polarization state of light. By defining the first dimension and the second dimension independently, the birefringent effects of the nanostructure at the particular nanostructure location may be counteracted.

At block 1110, the method of manufacturing 1100 may include at each nanostructure location on the optical metasurface, determining an azimuth angle (e.g., azimuth angle 884) of the nanostructure location from a base axis (e.g., x axis as depicted in FIG. 8). The azimuth angle corresponds to the angular position of the nanostructure location relative to the base axis. In some embodiments, the nanostructure location may be included in a quantized azimuth angle group representing a range of azimuth angles.

At block 1112, the method of manufacturing 1100 may include at each nanostructure location on the optical metasurface, determining an orientation (e.g., orientation 446) of the asymmetric nanostructure based on the azimuth angle. The orientation of the asymmetric nanostructure may determine the phase retardation experienced by different polarization states of light at the asymmetric nanostructure. For example, the first dimension of the asymmetric nanostructure may correspond to a first polarization state and the second dimension of the asymmetric nanostructure may correspond to the second polarization state. The asymmetric nanostructure may be oriented such that the first dimension corresponds to the first polarization state of incident light and the second dimensions corresponds to the second polarization state of incident light.

At block 1114, the method of manufacturing 1100 may include adding the asymmetric nanostructure and associated nanostructure location to an optical metasurface map. An optical metasurface map comprises any data structure configured to associate a nanostructure location on the optical metasurface with a particular asymmetric nanostructure. For example, an optical metasurface map may correlate an x, y location of the optical metasurface with an asymmetric nanostructure comprising a minor axis, a major axis, a height, an orientation, and so on. A metasurface map may be formatted to comply with any software protocol. For example, an optical metasurface map may be provided directly to a tool to manufacture one or more aspects of the optical metasurface. In a non-limiting example, the optical metasurface map may be provided to a manufacturing tool configured to generate a photolithographic mask, such that the optical metasurface may be manufactured through a photolithographic process.

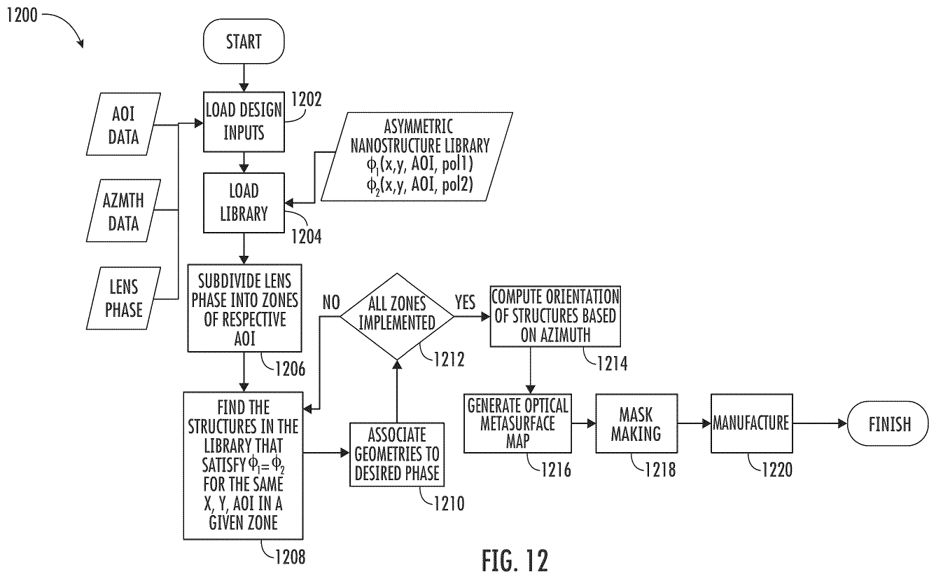

Referring now to FIG. 12, an example flow chart 1200 depicting an embodiment of a method of manufacturing an optical metasurface (e.g., optical metasurface 880) is provided. At step 1202, design inputs are loaded into a metasurface map generation device configured to generate an optical metasurface map. For example, a controller or processor. Design inputs may include angle of incidence (AOI) data, for example, an angle of incidence map (e.g., angle of incidence map 660). Design input may further include azimuth data (AZMTH data), for example, an azimuth angle map (e.g., azimuth angle map 770a) or quantized azimuth angle map (e.g., quantized azimuth angle map 770b). Design inputs may further include lens phase data, for example, a phase map (e.g., phase map 550) configured to generate a diffractive transmitted light pattern.

At sept 1204, an asymmetric nanostructure library may be loaded into the metasurface map generation device. The asymmetric nanostructure library may include the set of asymmetric nanostructures available to a manufacturing system. For example, in some embodiments, the size, orientation, and composition of an asymmetric nanostructure may be limited based on the manufacturing tool. The asymmetric nanostructure library may also include functionality to determine the phase retardation value of a particular asymmetric nanostructure based on the nanostructure location (e.g., x, y location) on the optical metasurface, the angle of incidence of incident light at the nanostructure location, and a given light polarization.

At step 1206, the phase map is subdivided into AOI zones based on the angle of incidence at the nanostructure location. For example, a first AOI zone may be formed of all nanostructure locations associated with an angle of incidence value between 0 degrees and 10 degrees. A second AOI zone may be formed of all nanostructure locations associated with an angle of incidence value between 10 degrees and 20 degrees, and so on.

At step 1208, the metasurface map generation device extracts a set of asymmetric nanostructures from the asymmetric nanostructure library for which the phase retardation value for the first polarization state of light and the phase retardation value for the second polarization state of light are equivalent given the same x, y location and angle of incidence in a particular zone.

At step 1210, an asymmetric nanostructure comprising an associated geometry is selected for each x, y location in the particular zone based on a match with the desired phase included in the phase map.

At step 1212, the metasurface map generation checks if all zones have been implemented. If not, processing continues at step 1208. If all zones have been implemented, processing continues at step 1214.

At step 1214, the orientation of each asymmetric nanostructure selected is determined based on the azimuth angle or quantized azimuth angle map.

At step 1216, the optical metasurface map is generated, correlating an asymmetric nanostructure to each nanostructure location.

At step 1218, one or more photolithography masks are generated based on the optical metasurface map.

At step 1220, an optical metasurface is manufactured based on the one or more photolithography masks.

While this detailed description has set forth some embodiments of the present invention, the appended claims cover other embodiments of the present invention which differ from the described embodiments according to various modifications and improvements. For example, one skilled in the art may recognize that such principles may be applied to any optical device configured to generate an accurate diffractive transmitted light pattern. For example, optical imaging sensors, illumination systems, optical ranging and proximity devices, optical identification devices, LIDAR devices, optical facial recognition devices, image capture, depth map generation, beam steering applications, machine vision, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. An optical metasurface comprising:
a plurality of asymmetric nanostructures comprising a cross-section defined at least by a first dimension and a second dimension, each asymmetric nanostructure positioned at a nanostructure location and configured to receive incident light;
wherein the first dimension is defined based on an angle of incidence of the incident light at the nanostructure location, and a phase retardation value associated with the nanostructure location;
wherein the second dimension is defined based on the angle of incidence of the incident light at the nanostructure location, and the phase retardation value associated with the nanostructure location; and
wherein the first dimension and the second dimension of the asymmetric nanostructure are defined to counteract a birefringent property at the angle of incidence.

2. The optical metasurface of claim 1, wherein the plurality of asymmetric nanostructures are defined to generate a diffractive transmitted light pattern based on the phase retardation values at each of the nanostructure locations.

3. The optical metasurface of claim 1, wherein the cross-section of each asymmetric nanostructure of the plurality of asymmetric nanostructures comprises a first axis and a second axis.

4. The optical metasurface of claim 3, wherein the first axis is defined based on a first polarization state of the incident light, the angle of incidence of the incident light at the nanostructure location of the asymmetric nanostructure, and the phase retardation value associated with the nanostructure location,
wherein the first polarization state of the incident light is aligned with the first axis of the asymmetric nanostructure.

5. The optical metasurface of claim 4, wherein the second axis is defined based on a second polarization state of the incident light, the angle of incidence of the incident light at the nanostructure location of the asymmetric nanostructure, and the phase retardation value associated with the nanostructure location,
wherein the second polarization state of the incident light is aligned with the second axis of the asymmetric nanostructure.

6. The optical metasurface of claim 1, wherein the angle of incidence of the incident light is based on a distance between a center of the optical metasurface and the nanostructure location.

7. The optical metasurface of claim 6, wherein a difference between the first dimension and the second dimension increases as the distance from the center of the optical metasurface of the nanostructure location increases.

8. The optical metasurface of claim 1, wherein the first polarization state of incident light and the second polarization state of incident light are orthogonal.

9. The optical metasurface of claim 1, wherein the asymmetric nanostructure is further defined by an orientation.

10. The optical metasurface of claim 9, wherein the orientation is determined based on an azimuth angle from a base axis.

11. The optical metasurface of claim 10, wherein an orientation angle of the asymmetric nanostructure is equal to the azimuth angle.

12. The optical metasurface of claim 10, wherein a plurality of quantized azimuth angle groups are defined, wherein each quantized azimuth angle group is associated with a range of azimuth angles.

13. The optical metasurface of claim 12, comprising sixteen quantized azimuth angle groups each quantized azimuth angle groups associated with a range of azimuth angles of 22.5 degrees.

14. An illumination system comprising:
an optical illumination source configured to transmit incident light through an optical illumination source; and
the optical metasurface comprising:
a plurality of asymmetric nanostructures comprising a cross-section defined at least by a first dimension and a second dimension, each asymmetric nanostructure positioned at a nanostructure location and configured to receive the incident light;
wherein the first dimension is defined based on an angle of incidence of the incident light at the nanostructure location, and a phase retardation value associated with the nanostructure location;
wherein the second dimension is defined based on the angle of incidence of the incident light at the nanostructure location, and the phase retardation value associated with the nanostructure location; and
wherein the first dimension and the second dimension of the asymmetric nanostructure are defined to counteract a birefringent property at the angle of incidence.

15. The illumination system of claim 14, wherein the angle of incidence is determined based on a position of the optical illumination source relative to the optical metasurface.

16. An optical imaging sensor comprising:
an optical metasurface configured to transmit incident light toward an image sensor opposite the optical metasurface from the incident light, the optical metasurface comprising:
a plurality of asymmetric nanostructures comprising a cross-section defined at least by a first dimension and a second dimension, each asymmetric nanostructure positioned at a nanostructure location and configured to receive the incident light;
wherein the first dimension is defined based on an angle of incidence of the incident light at the nanostructure location, and a phase retardation value associated with the nanostructure location;
wherein the second dimension is defined based on the angle of incidence of the incident light at the nanostructure location, and the phase retardation value associated with the nanostructure location; and
wherein the first dimension and the second dimension of the asymmetric nanostructure are defined to counteract a birefringent property at the angle of incidence.

17. The optical imaging sensor of claim 16, further comprising:
a sensor housing comprising an aperture configured to receive the incident light;
an optical lens positioned between the aperture and the optical metasurface, the optical lens configured to receive the incident light passing through the aperture.

18. A method of manufacturing an optical metasurface, the method comprising:
determining a phase map for the optical metasurface, wherein the phase map defines a diffractive transmitted light pattern;
for each nanostructure location on the optical metasurface:
determining an angle of incidence of incident light at the nanostructure location;
determining a phase retardation value at the nanostructure location based on the phase map;
defining an asymmetric nanostructure based on the phase retardation value, comprising a cross-section defined at least by a first dimension and a second dimension,
wherein the first dimension is defined based on an angle of incidence of the incident light at the nanostructure location, and a phase retardation value associated with the nanostructure location;
wherein the second dimension is defined based on the angle of incidence of the incident light at the nanostructure location, and the phase retardation value associated with the nanostructure location; and
wherein the first dimension and the second dimension of the asymmetric nanostructure are defined to counteract a birefringent property at the angle of incidence.

19. The method of manufacturing of claim 18, further comprising:
determining an azimuth angle of the nanostructure location from a base axis; and
determining an orientation of the asymmetric nanostructure based on the azimuth angle.

20. The method of manufacturing of claim 18, further comprising adding the asymmetric nanostructure and associated nanostructure location to an optical metasurface map.
